(19) United States
(12) Patent Application Publication
(10) Pub. No.: US 2011/0282618 A1
(43) Pub. Date: Nov. 17, 2011

(54) PROCESSING METHOD FOR A SENSOR WITH SINGLE-PHOTON SENSITIVITY AND DEVICE USING SAME

(75) Inventors: Rémi Barbier, Lyon (FR); Nicolas Estre, Puyricard (FR)

(73) Assignees: CENTRE NATIONAL DE LA RECHERCHE SCIENTIFIQUE, Paris Cedex 16 (FR); UNIVERSITE CLAUDE BERNARD LYON I, Villeurbanne (FR)

(21) Appl. No.: 13/133,501

(22) PCT Filed: Dec. 8, 2009
(86) PCT No.: PCT/FR09/52455

§ 371 Date: Jul. 27, 2011

(30) Foreign Application Priority Data
Dec. 11, 2008 (FR) 0858504

(51) Int. Cl. G01D 1/04; G06F 15/00

(52) U.S. Cl. 702/128

(57) ABSTRACT

A photon detecting device including a sensor including a vacuum chamber, a photocathode arranged therein to convert photons to primary electrons, a converter converting at least part of the energy of accelerated primary electrons to secondary charges collected by a plurality of detection cells, an acquisition circuit adapted to read the charges collected by the detection cells with an integration time allowing an impact density to be obtained per unit of time and per unit surface of a cell of the order of a single electron, a system identifying a cluster of adjacent detection cells of which at least one so-called main cell includes a quantity of collected charges higher than a threshold value, a system determining at least one characteristic of the cluster, a system memorizing at least one characteristic of a reference cluster resulting from conversion of a primary electron, and a system comparing the determined characteristic(s) of the cluster with the memorized characteristic(s) of the reference cluster to evidence whether the cluster results from the conversion of a primary electron.

The technical field of the invention concerns the detection of photons in scenes with low light level.

More particularly, the invention concerns the field of photon detection devices comprising a sensor having sensitivity for single-photon detection, and their methods of implementation.

The invention finds preferred, but non-exclusive application in the field of processing Night Vision scenes, for example in the area of defence and security, or scientific and industrial imaging such as fluorescence microscopy.

In the state of the art, for this purpose it is known to use an Electro Bombarded Complementary Metal-Oxide Semiconductor, abbreviated to EBCMOS.

Document WO 0106571 describes said sensor which is composed of a photocathode and of an array of silicon pixels. These two components are sealed and form a vacuum chamber.

The photocathode converts the photons emitted by at least one light source into primary electrons, by photoelectric effect. The primary electrons are accelerated in the direction of the pixel array by an electromagnetic field which imparts sufficient kinetic energy to these electrons so that they can be individually detected.

The pixel array comprises a detection volume, arranged facing the photocathode, the accelerated primary electrons entering this volume. The interaction of the primary electrons within the detection volume sets up charges which diffuse as far as diodes arranged at a regular pitch, e.g. in an array, and adapted to collect the charges whilst optimizing read-out noise. The elementary diode unit corresponds to a pixel and it is possible to have several diodes per pixel.

The accumulation of charges in the diodes allows the forming of electric signals that are processed so as to generate a video signal composed of a succession of images. Each image corresponds to the sum of energies deposited in the pixels during an integration time of the sensor.

This type of sensor was chiefly designed for use in scenes with low light level, for example for night vision, with image frequencies of the order of 25 Hz corresponding to an integration time of 40 ms.

However, the pixel array also converts electrons which are not derived directly from the photocathode after conversion of a photon, which is undesired. This generates parasitic effects in the image recorded by the pixel array.

One first type of parasitic effect is the halo effect. This is due to the backscattering of primary electrons on the pixel array, to their re-acceleration in the direction of the pixel array and to detection thereof by the array. The image effectively assumes the sum of the energies deposited in the pixels during the integration time of the sensor, whether this energy derives from backscattered electrons or from primary electrons. For scenes with low light levels i.e. less than one mLux, and containing a localized more intense source, an accumulation of charges occurs due to the backscattered electrons, which leads to the formation of a circular halo around the image of the source. The radius of the halo is equal to no more than twice the distance between the photocathode and the pixel array. All the images of the objects contained in this halo disappear. With distances between the photocathode and the pixel array usually of the order of one millimetre, the halo may cover a large part of the sensor surface and the sensor loses its entire function.

A second type of parasitic effect is the so-called effect of “ion back bombardment at the photocathode”. A residual atom present in the vacuum chamber may be ionized by the primary electrons before it is itself accelerated towards the photocathode. This is followed by localized pulling of numerous electrons from the photocathode, these being accelerated in the direction of the pixel array. This high density of electrons translates as an intense point in the resulting image.

A third type of parasitic effect is the so-called “dark count” effect. This effect results from electronic emission background noise derived from the emission of electrons by the photocathode under thermionic effect or field effect. For images of scenes with low light level, electronic background noise is responsible for a random snow effect in the reconstructed scenes.

To endeavour to reduce the phenomenon of electron backscattering and hence the halo phenomenon, patent application US 2005/0122021 proposes that the electron collecting surface should have a textured surface. In addition to the problem of manufacturing said surface, this solution eliminates part of the sensitive collecting surface and does not allow the parasitic effects in a recorded image to be reduced.

It is one objective of the invention to allow the detection or recognition of photons in scenes with low light levels despite the presence of parasitic effects.

A further objective of the invention is to propose a method for processing data produced by a sensor adapted for the processing of scenes with low light levels, which allows the detection of so-called primary electrons resulting from the conversion of photons.

For this purpose, the method of the invention uses the data produced by a sensor of the type comprising a vacuum chamber, a photocathode arranged in the chamber, designed to convert the photons emitted by at least one light source into primary electrons and subjected to an electromagnetic field adapted to accelerate the primary electrons, a converter converting electrons into secondary charges arranged in the chamber facing the photocathode and adapted to convert at least part of the energy of the accelerated primary electrons into secondary charges collected by a plurality of detection cells distributed at a regular pitch, the converter also converting so-called parasitic electrons not directly derived from the conversion of a photon and possibly being of backscattered type, of the type resulting from ion back bombardment or of the type derived from electronic emission background noise, and an acquisition circuit adapted to read the charges collected by the detection cells with an integration time allowing an impact density to be obtained per unit of time and per unit of cell surface of the order of a single electron.

According to the invention, the method comprises the following steps:
identifying a cluster of adjacent detection cells of which one cell called the main cell comprises a quantity of collected charges higher than a threshold value,
determining at least one characteristic of the cluster,
comparing the determined characteristic(s) of the cluster with at least one characteristic of a cluster resulting from the conversion of a primary electron, to evidence a cluster resulting from the conversion of a primary electron.

According to one variant of embodiment, the method further comprises a step to eliminate a cluster identified as not resulting from the conversion of a primary electron.

According to one advantageous variant of embodiment, the method further comprises a confrontation step between firstly the determined characteristic(s) of the cluster and secondly at least one characteristic of a cluster resulting from the conversion of a backscattered electron, in order to identify a cluster resulting from the conversion of a backscattered electron, and a step to eliminate clusters evidenced during the confrontation step.

This variant advantageously allows the elimination of halo effects due to backscattered electrons, when detecting a scene with low light level comprising a localized more intense source.

According to one advantageous variant of embodiment, the method comprises a step to search for similarity between firstly the determined characteristic(s) of the cluster and secondly at least one characteristic of a cluster resulting from ion back bombardment, in order to identify a cluster resulting from ion back bombardment, and a step to eliminate clusters evidenced during the confrontation step.

This variant advantageously allows the elimination of the effects of ion back bombardment at the photocathode.

According to one advantageous variant of the embodiment, the method also comprises the following steps:
determining the position of the photon at the origin of each identified, non-eliminated cluster,
storing at least part of all the determined positions,
comparing each new determined position with the stored positions,
identifying, from the result of comparison, the new positions which are not included in the stored positions, in order to evidence the positions of electrons resulting from the electronic background noise,
eliminating the new positions evidenced by the identification step.

This variant advantageously allows elimination of the effects of electronic emission background noise derived from the emission of electrons by the photocathode by thermionic effect or by field effect.

The method according to the invention may further comprise at least one of the following characteristics:
the identification step of the cluster comprises a step for evidencing at least the main cell whose quantity of collected charges is higher than a threshold value, and a recognition step of the cluster from the charges collected in the cells adjacent the main detection cell,
the method comprises a step for generating a video signal from the identified, non-eliminated clusters,
the method comprises a step for generating a position signal from the determined, non-eliminated positions.

A further object of the invention is to propose a device for detecting photons in scenes with low light level despite the presence of parasitic effects.

For this purpose, a photon detection device according to the invention comprises a sensor comprising a vacuum chamber, a photocathode arranged in the vacuum chamber designed to convert photons to primary electrons and subjected to an electromagnetic field adapted to accelerate the primary electrons, a converter converting electrons to secondary charges arranged in the vacuum chamber facing the photocathode and adapted to convert at least part of the energy of the accelerated primary electrons into secondary charges collected by a plurality of detection cells distributed at a regular pitch, the converter also converting so-called parasitic electrons not derived directly from the conversion of a photon and possibly being of backscattered type, of the type resulting from ion back bombardment or of the type derived from electron emission background noise, and an acquisition circuit adapted to read the charges collected by the detection cells with an integration time allowing an impact density to be obtained per unit of time and per unit of cell surface of the order of a single electron.

According to the invention, the detection device also comprises a system for identifying a cluster of adjacent detection cells of which at least one cell called the main cell comprises a quantity of collected charges that is higher than a threshold value, a system for determining at least one characteristic of the cluster, a system for memorizing at least one characteristic of a cluster resulting from conversion of a primary electron, and a system for comparing the characteristic(s) of the cluster with the memorized characteristic(s) of a cluster resulting from the conversion of a primary electron in order to evidence a cluster resulting from the conversion of a primary electron.

According to one variant of embodiment, the detection device comprises a system for eliminating a cluster identified by the comparison system as not resulting from the conversion of a primary electron.

According to one advantageous variant of embodiment, the memory system memorizes at least one characteristic of a cluster resulting from the conversion of a backscattered electron, and the device comprises a system for confronting the determined characteristic(s) of the cluster with the memorized characteristic(s) of a cluster resulting from the conversion of a backscattered electron in order to evidence a cluster resulting from the conversion of a backscattered electron, and the device comprises a system for eliminating a cluster evidenced by the confronting system.

This variant advantageously prevents the formation of a halo effect in a scene with low light level comprising a localized more intense source.

According to one advantageous variant of embodiment, the memory system memorizes at least one characteristic of a cluster resulting from ion back bombardment, and the device comprises a system for confronting the determined characteristic(s) of the cluster with the memorized characteristic(s) of a cluster resulting from ion back bombardment in order to evidence a cluster resulting from ion back bombardment, and the device comprises a system for eliminating a cluster evidenced by the confronting system.

This variant advantageously allows elimination of the effects of ion back bombardment at the photocathode.

According to one advantageous variant of embodiment, the device further comprises a system for determining the position of the photon at the origin of each identified, non-eliminated cluster, a system for storing at least part of all the determined positions, a system for comparing each new determined position with the stored positions, a system using the result of comparison to identify new positions which are not included in the stored positions, in order to evidence the positions of electrons resulting from electronic emission background noise by thermionic effect or by field effect, and a system for eliminating the positions evidenced by the identification system.

This variant advantageously allows the elimination of the effects of electronic emission background noise derived from the emission of electrons by the photocathode under thermionic effect or by field effect.

The device of the invention may further comprise at least one of the following characteristics:
the identification system of the cluster comprises a system for identifying at least one main cell whose quantity of collected charges is higher than a threshold value, and a system for recognizing the cluster from the collected charges in the cells adjacent the main detection cell,
the device comprises a system for generating a video signal from identified, non-eliminated clusters during a given time interval,
the device comprises a system for generating a position signal from each determined, non-eliminated position.

Various other characteristics will become apparent from the description given below with reference to the appended drawings which, as non-limiting examples, illustrate embodiments of the subject of the invention.

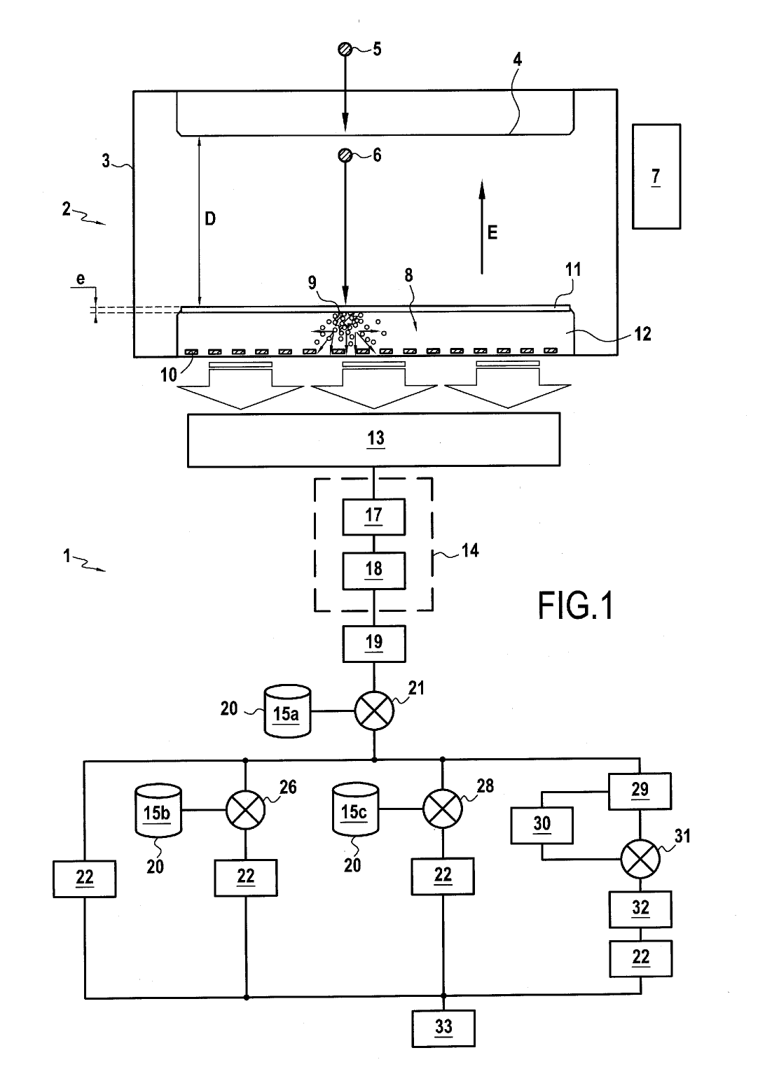

FIG. 1 is a diagram showing an example of embodiment of a device according to the invention.

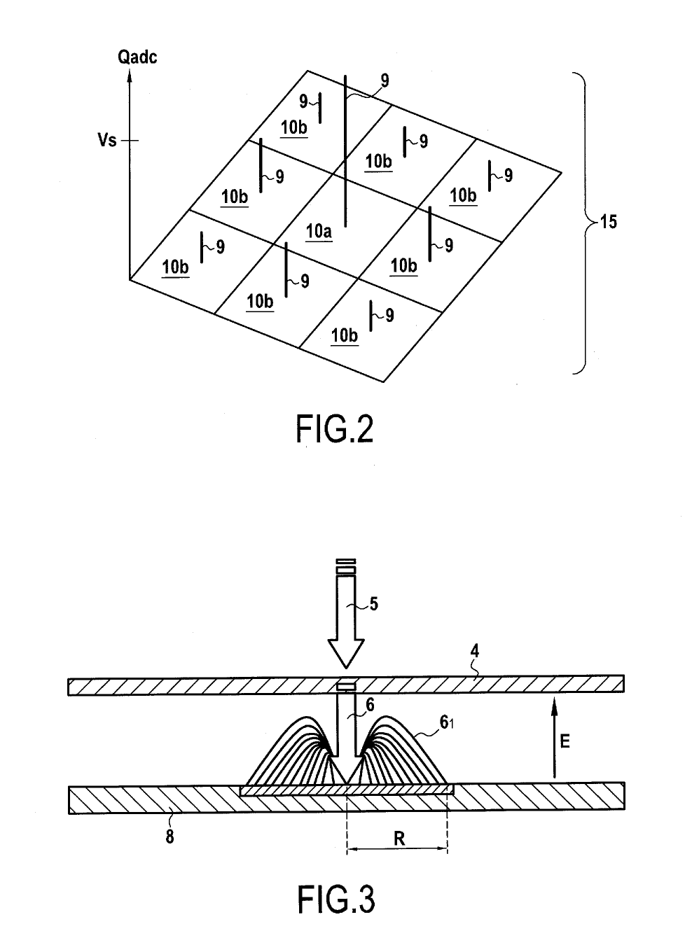

FIG. 2 shows an example of a cluster resulting from the conversion of a primary electron, and the quantities of charges collected in the cells of the cluster.

FIG. 3 is a diagram explaining the halo effect.

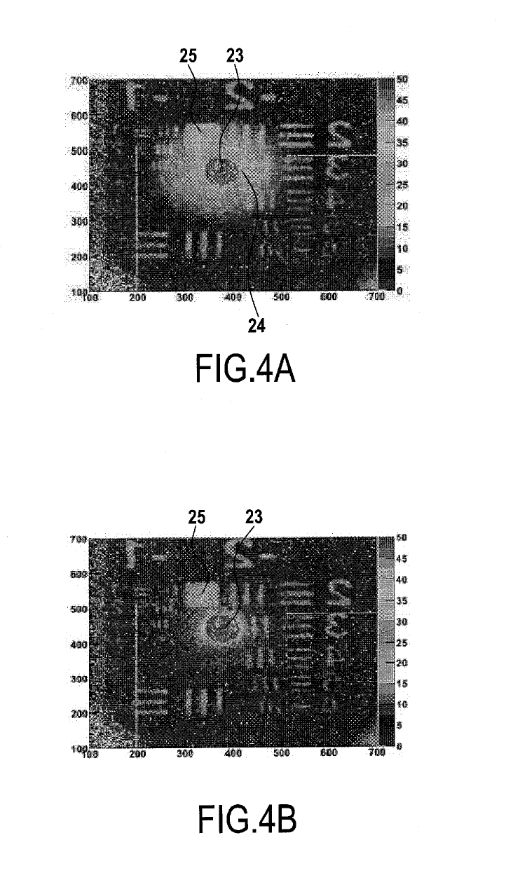

FIG. 4A is an image obtained with a sensor of usual EBCMOS type and containing a halo effect.

FIG. 4B is an image similar to the image in FIG. 4A but obtained with a device according to the invention.

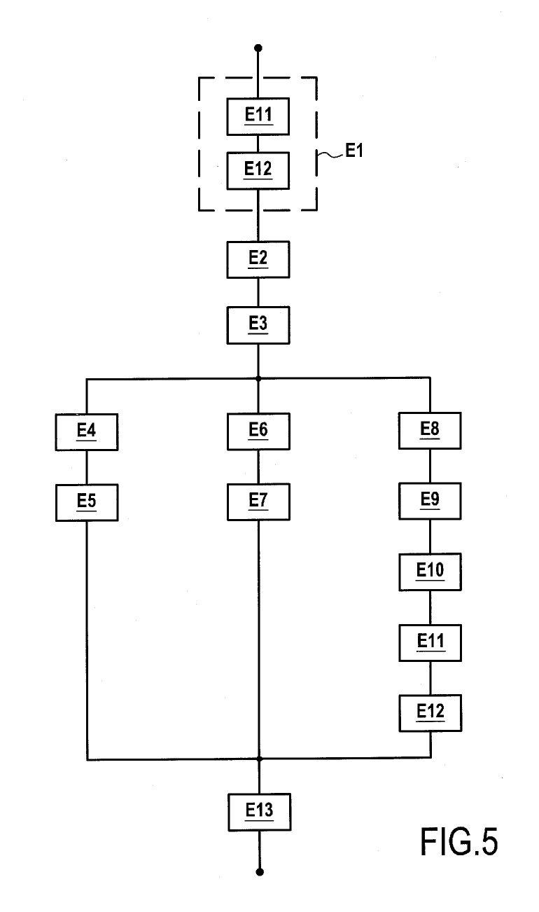

FIG. 5 is a logical diagram of the method of the invention.

The photon detection device 1 shown FIG. 1 is adapted for scenes with low light level. This detection device 1 comprises a sensor 2 which is built with single-photon detection sensitivity. In the illustrated preferred embodiment, this sensor 2 is of EBCMOS type. Evidently the invention is not limited to devices provided with a sensor of this type. Any silicon sensor capable of single-photoelectron sensitivity such as hybrid pixels for example or CMOS sensors of SOI type (Silicon-On-Insulator) can be used under the invention.

The device 1 comprises a given vacuum chamber 3 and a photocathode 4 arranged in the chamber 3. The photocathode 4 is adapted to convert photons 5 emitted by at least one light source, not illustrated, into electrons. The group of photons emitted by the source(s) and converted at least in part by the device defines an incident flow. In the present description, the electrons resulting from the conversion of a photon 5 by the photocathode 4 are called primary electrons 6.

The photons 5 can derive from the visible spectrum and/or near infrared and/or near ultraviolet for example.

The photocathode 4 is subjected to an electromagnetic field E induced by a potential difference and set up by means of a system 7 for generating the electromagnetic field E. The said electromagnetic field E is adapted to accelerate the primary electrons 6 from the photocathode 4 as far as an electron converter 8, so as to generate impacts of primary electrons 6 on the electron converter. The photocathode 4 lies distant from the electron converter 8 by a separating distance D.

The value of the electromagnetic field E is adapted to impart sufficient kinetic energy to the primary electrons 6 to allow the individual detection of each primary electron 6 by the sensor 2.

The electron converter 8 is adapted to convert at least part of the energy of the accelerated primary electrons 6 into secondary charges 9 collected by a plurality of detection cells 10 distributed at a regular pitch, for example in an array.

In the illustrated example of embodiment, the electron converter 8 comprises a so-called passive input layer 11, having a thickness e, arranged facing the photocathode 4 and through which at least part of the primary electrons 6 pass. The electron converter 8 also comprises a detection volume 12, adjacent the input layer 11, in which at least the primary electrons 6 interact to form electron-hole pairs which diffuse as far as the detection cells 10, preferably diodes arranged in an array.

Preferably the electron converter 8 is a CMOS component (Complementary Metal-Oxide Semiconductor) and of MAPS type (Monolithic Active Pixel Sensor). Evidently, other types of primary electron converters 8 can be used under the invention such as an electron converter for example provided with a sensitive layer connected via beads or TSVs (Through Silicon Via) to a CMOS reading circuit.

The device 1 further comprises an acquisition circuit 13 adapted to read out the charges 9 collected by the detection cells 10 with an integration time adapted to obtain an impact density on the electron converter 8 per unit of time and per unit surface of a cell 10 of the order of a single electron. The integration time is preferably equal to or less than 1 ms.

According to one advantageous variant of embodiment, the integration time is calculated, whether or not dynamically, by a system computing the integration time, not illustrated, in relation to the size of the detection cells 10 and the incident light flux.

The acquisition circuit 13 is adapted to offer a ratio between the read-out charges 9 and a read-out noise generated on reading the detection cells 10, adapted to allow detection sensitivity to single-photons 5. The ratio between the read-out charges 9 and read-out noise is dependent at least on the value of the electromagnetic field E, on the thickness e of the passive layer of the electron converter 8 and on the separating distance D between the photocathode 4 and the electron converter 8.

According to the invention, the device 1 further comprises an identification system 14 to identify a cluster 15 of which one example is illustrated FIG. 2. Here, FIG. 2 illustrates a cluster 15 resulting from the conversion of a primary electron.

The identification system 14 identifies a cluster 15 of adjacent detection cells 10 of which at least one so-called main cell 10a contains a quantity of collected charges 9 that is higher than a threshold value Vs, from the charges 9 read by the acquisition circuit 13.

Preferably, the chosen threshold value Vs is dependent on the value of the read-out noise of the detection cell 10. The threshold value Vs is preferably equal to 5 times the value of the read-out noise.

According to the illustrated preferred embodiment, the identification system 14 comprises a system 17 for evidencing at least the main cell 10a whose quantity of collected charges 9 is higher than the threshold value Vs. The identification system 17 further comprises a recognition system 18 recognizing the cluster 15 from the quantities of charges 9 collected in the cells 10b adjacent the main cell 10a.

The optimal size of the cluster 15, i.e. the number of adjacent cells 10 taken into account, is variable and is dependent upon the distribution of charges 9 around the main cells 10a and on the pitch of the detection cells 10. Preferably, the size of the cluster 15 is 3×3, 5×5 or 7×7 detection cells 10. In the illustrated example of embodiment, the size of the cluster 15 is 3×3 detection cells 10.

The optimal size of the cluster 15 may advantageously be computed, whether or not dynamically, by a system for determining the optimal cluster size, not illustrated.

Advantageously, the identification system 14 identifying a cluster 15 allows the identification of regions potentially corresponding to an impact of a primary electron 6 on the electron converter 8 with a view to analysis thereof.

The device 1 further comprises a determination system 19 determining at least one characteristic of the cluster 15.

Preferably, the determination system 19 determines the total quantity of charges 9 collected in the cluster 15 by summing the charges 9 collected in the main cells 10a and adjacent cells 10b of the cluster 15.

According to different variants of embodiment, the determination system 19 is able to determine other characteristics of the cluster 15 such as its topology for example or its mean density of charges 9.

For example the cells 10a, 10b whose quantity of collected charges 9 is the highest may form a cross- or square-shaped pattern depending on whether the impact of the electron at the origin of the cluster 15 lies respectively above a single cell 10a, 10b or between 4 cells 10a, 10b.

The device 1 further comprises a memory system 20 to memorize at least one characteristic of a reference cluster 15a resulting from the conversion of a primary electron 6. The characteristics of the reference cluster 15a are known per se, and the choice of characteristic(s) is purely arbitrary depending on the embodiment of the device 1.

Preferably, the memory system 20 memorizes the total quantity of charges 9 of the reference cluster 15a which ranges from 220 to 280 Qadc and is preferably 250 Qadc for a mean noise per cell of 3 Qadc.

According to one variant of embodiment, the memory system 20 memorizes the mean density of charges 9 of the reference cluster 15a which ranges from 24 to 30 and is preferably 27 Qadc/cell for an array of 3×3 cells 10 with a pitch of 17 μm.

The device 1 further comprises a comparison system 21 comparing the determined characteristic(s) of the cluster 15 with the memorized characteristic(s) of the reference cluster 15a, in order to evidence whether the cluster 15 results from the conversion of a primary electron 6. In other words, the cluster 15 is compared with the reference cluster 15a which has a known profile, so as to determine whether these clusters 15, 15a are similar.

Preferably, the comparison system 21 compares the total quantity of charges 9 collected in the cluster 15 with the total quantity of charges in the reference cluster 15a.

The device 1 of the invention thereby allows simple reliable identification of the primary electrons resulting from photon conversion.

The device 1 allows an image and/or a video signal to be generated, formed of a succession of images, each image being generated from the sum of the charges 9 collected by the detection cells 10 during the integration time of the sensor 2.

However it is to be noted that the electron converter 8 also, and which is undesired, converts so-called parasitic electrons into secondary charges 9, these parasitic electrons not deriving from the conversion of a photon 5. The parasitic electrons may be at least of backscattered type, of the type resulting from ion back bombardment or of the type derived from electronic emission background noise. Each type of parasitic electron generates a different type of parasitic effect. The parasitic electrons of backscattered type generate a halo parasitic effect, the parasitic electrons of the type resulting from ion back bombardment generate a so-called “ion back bombardment” parasitic effect, and parasitic electrons of the type derived from electron emission background noise by the photocathode generate a so-called “dark count” parasitic effect.

Therefore, it is advantageous to identify and preferably eliminate the clusters 15 resulting from conversion of parasitic electrons so as only to keep those clusters 15 resulting from the conversion of primary electrons 6 in order to generate an image and/or video signal without parasitic effects.

According to one variant of embodiment, any cluster 15 whose determined characteristics have at least one difference compared with the memorized characteristic(s) of the reference cluster 15a is considered to be a cluster resulting from the conversion of a parasitic electron and is therefore eliminated. The device 1, according to this variant of embodiment, comprises an elimination system 22 connected to the output of a comparison system 21 and adapted to eliminate those clusters 15 identified by the comparison system 21 as not resulting from the conversion of a primary electron.

According to one advantageous variant of embodiment, the device 1 allows the identification of at least one and preferably of the three types of parasitic electrons defined above, for example with a view to elimination thereof.

As explained in FIG. 3, the halo effect is due to electrons 6₁ backscattered by the electron converter 8 i.e. scattered by the electron converter in the direction of the photocathode 4. Between 12% and 18% of the primary electrons 6 are backscattered by the electron converter 8, accelerated by the electromagnetic field E in the direction of the photocathode 4 then detected at a position different from the position of the initial primary electron 6. It is possible for example, using simulations performed using the Monte-Carlo method or using analytical calculations, to show that the distance R travelled by a backscattered electron between the primary impact and the secondary impact is equal to no more than twice the distance between the photocathode 4 and the electron converter 8.

FIG. 4A shows an image of a scene with low light level i.e. less than one mLux, and containing a localized more intense source formed of an optical fibre 23. This image derives from a usual EBCMOS sensor 2 according to the state of the art. The accumulation of charges 9, due to the backscattered electrons 6₁, leads to the formation of a circular halo 24 around the more intense source. All the images of the objects contained in the halo 24, for example an object 25, are attenuated and/or masked by the halo 24.

According to one embodiment of the invention advantageously adapted to eliminate the halo effect, the memory system 20 memorizes at least one characteristic of a standard cluster 15b resulting from the conversion of a backscattered electron 6₁.

The characteristics of the standard cluster 15b are known per se, and the choice of characteristic(s) is purely arbitrary and depends upon the embodiment of the device 1.

Preferably the memory system 20 memorizes the total quantity of charges 9 of the standard cluster 15b which ranges from 75 to 125 Qadc and is preferably 125 Qadc.

According to this variant, the device 1 also comprises a confrontation system 26 confronting the determined characteristic(s) of the cluster 15 with the memorized characteristic(s) of the standard cluster 15b in order to evidence whether the cluster 15 results from the conversion of a backscattered electron 6₁. In other words, the cluster 15 is compared with the standard cluster 15b which is of known profile, so as to determine whether these clusters 15, 15b are similar.

Preferably, the confrontation system 26 confronts the total quantity of charges 9 collected in cluster 15 with the total quantity of charges 9 in the standard cluster 15b. According to this variant, the device 1 preferably comprises an elimination system 12 to eliminate the cluster 15 corresponding to a backscattered electron 6₁ evidenced by the confrontation system 26.

FIG. 4b illustrates a similar image to the image in FIG. 4A but obtained with a device 1 of the invention adapted to eliminate halo effects. The images of the objects close to the light source 23, for example object 25, are not masked.

The effect of ion back bombardment at the photocathode 4 is due to ionization by the primary electrons 6 of a residual atom present in the chamber 3. Once positively ionized, the residual atom is accelerated by the electromagnetic field E in the direction of the photocathode 4. This results in localized pulling away of numerous electrons from the photocathode 4, these pulled electrons themselves being accelerated in the direction of the electron converter 8.

According to one embodiment of the invention advantageously adapted to eliminate the effect of ion back bombardment, the memory system 20 memorizes at least one characteristic of a model cluster 15c resulting from ion back bombardment. The characteristics of the model cluster 15c are known per se and the choice of characteristic(s) is purely arbitrary and depends on the embodiment of the device 1. Preferably, the memory system 20 memorizes the total quantity of charges 9 of the model cluster 15c which ranges from 1000 to 4000 Qadc and is preferably 2000 Qadc. According to one variant of embodiment, the memory system 20 memorizes the mean density of charges 9 of the model cluster 15c which lies between 40 and 60 Aadc/cell and is preferably 50 Qadc/cell in an array of 7×7 cells 10 with a pitch of 17 μm.

According to this variant, the device 1 further comprises a similarity search system 28 between the determined characteristic(s) of cluster 15 and the memorized characteristic(s) of the model cluster 15c, in order to evidence whether cluster 15 results from ion back bombardment. In other words, the similarity search system 28 carries out a comparison between cluster 15 and the model cluster 15c which is of known profile so as to determine whether these clusters 15, 15c are similar. Preferably, the similarity search system 28 confronts the total quantity of charges 9 collected in cluster 15 with the total quantity of charges 9 in the model cluster 15c.

The device 1 preferably comprises an elimination system 22 to eliminate a cluster 15 considered as resulting from ion back bombardment and evidenced by the similarity search system 28.

The effect of electronic emission background noise is due to electrons spontaneously and randomly emitted by the photocathode 4 under thermionic effect or field effect. For images of scenes with low light levels, this type of effect translates as a random “snow” effect in the image. Advantageously, it is possible to detect the electrons of the type derived from electronic emission background noise by determining whether or not they are randomly localized.

For this purpose the device 1, according to one variant of the invention adapted to eliminate the effects of electronic emission background noise, comprises a determination system 29 to determine the position of the photon 5 at the origin of each identified and non-eliminated cluster 15. According to this variant, the device 1 further comprises a storage system 30 to store at least part of all the determined positions, and a comparison system 31 comparing each new determined position with the stored positions. The determination system 29 and the storage system 30 are therefore connected to the comparison system 31.

The device 1 preferably comprises an identification system 32 using the result of the comparison of the new positions which are not included in the stored positions, in order to evidence the positions of photons resulting from electronic emission background noise.

In other words, the identification system 32 determines whether each new position is already included in the stored positions, in which case the new position probably corresponds to a photon 5 emitted by one of the light sources, or whether it is not included in the stored positions in which case it probably corresponds to the conversion of an electron of the type derived from electronic emission background noise by the electron converter 8.

The device 1 also preferably comprises an elimination system 22 to eliminate those positions evidenced by the identification system 32.

Evidently, the positions eliminated by the elimination system 32 may be stored by the storage system 30 for the purpose of being compared with subsequent positions. Advantageously, this characteristic prevents the elimination of photons from an apparent light source.

It is to be noted that the embodiment adapted to eliminate the halo effect, the embodiment adapted to eliminate the ion back bombardment effect and the embodiment adapted to eliminate electronic emission background noise are not incompatible. A device 1 according to the invention is able to implement one and/or the other of these embodiments in combination, and preferably all three.

Finally, the device 1 comprises a system 33 for generating an output signal. According to one variant of the invention, this signal is a video signal composed of a plurality of images, and the system 33 generating an output signal comprises a system for generating a video signal from identified and non-eliminated clusters during a given time interval, for example 40 ms, so as to obtain an image frequency of 25 Hz.

According to one variant of the invention, this signal is a digital signal giving the positions of the detected photons. In this case, the system 33 for generating a signal is composed of a system for generating a position signal from each determined and non-eliminated position.

Advantageously, this variant allows the subsequent reconstitution at will of an image by an external processing system, not illustrated, from the successive positions of the photons.

According to one variant of embodiment it is to be noted that, using the position signal, it can be envisaged to determine the position of a point emitter of single photons per image and optionally to track the position of this point emitter.

The method of the invention, of which the logical diagram is given FIG. 5, processes the data produced by a sensor 2 built for single-photon sensitivity, for the purpose of identifying primary electrons derived from the conversion of photons to allow the optional overcoming of at least one type of parasitic effect when processing scenes with low light levels.

These parasitic effects may be of several types which include a halo parasitic effect, a so-called “ion back bombardment” parasitic effect and a so-called “dark count” parasitic effect.

In this example of embodiment and preferably, the method of the invention is designed for implementation on the device 1 according to the invention and/or to process data derived from a sensor 2 according to the invention. Evidently, it is possible to implement said method on a device not conforming to the subject of the invention.

The method comprises a first step E1 to identify a cluster 15 of adjacent detection cells 10 of which at least one so-called main cell 10a comprises a quantity of collected charges 9 that is higher than a determined threshold value Vs. In the illustrated example of embodiment, the identification of the cluster 15 is made by means of the identification system 14.

According to one variant of embodiment, step E1 comprises a first identification sub-step E11 to identify at least the main cell 10a whose quantity of collected charges 9 is higher than the threshold value Vs, and a second sub-step E12 for recognition of the cluster 15 from the quantities of collected charges 9 in the cells 10b adjacent the main cell 10a. In the illustrated example of embodiment, the identification of the main cell 10a is performed by means of the evidencing system 17 and recognition of the cluster 1 is performed by the recognition system 18.

Next, at a second step E2, the method determines at least one characteristic of the cluster 15. In the illustrated example of embodiment, the determination is performed by means of the determination system 19. Preferably the second step E2 determines the total quantity of charges 9 collected in the cluster 15 by summing the charges 9 collected in the different cells 10a, 10b of the cluster 15.

The method, at a third step E3, then compares the determined characteristic(s) of the cluster 15 with at least one characteristic of a reference cluster 15a resulting from the conversion of a primary electron 6, in order to evidence whether the cluster 15 results from the conversion of a primary electron 6. In other words, the method compares cluster 15 with the reference cluster 15a of known profile so as to determine whether these clusters 15, 15a are similar.

The characteristics of the reference cluster 15a are known per se and the choice of characteristic(s) is purely arbitrary and is dependent upon the embodiment of the method of the invention. In the illustrated example of embodiment, the comparison performed by the comparison system 21. Preferably, the third step E3 compares the total quantity of charges 9 collected in cluster 15 with the total quantity of charges 9 in the reference cluster 15a.

Preferably, at least the first, the second and the third step are successively and continuously repeated.

The method of the invention therefore allows the detection of photons through the identification of those clusters resulting from the conversion of primary electrons.

According to one variant of embodiment, not illustrated, it is to be noted that the method can implement a step to eliminate clusters identified as not resulting from the conversion of primary electrons.

According to one variant advantageously adapted to eliminate halo effects, the method comprises a fourth step E4 to confront the determined characteristic(s) of the cluster 15 with at least one characteristic of a standard cluster 15b resulting from the conversion of a backscattered electron 6₁ in order to identify whether the cluster 15 results from the conversion of a backscattered electron 6₁. The method therefore compares the cluster 15 with the standard cluster 15b which is of known profile so as to determine whether these clusters 15, 15b are similar.

The characteristics of the standard cluster 15b are known per se, and the choice of characteristic(s) is purely arbitrary and is dependent upon the embodiment of the method of the invention.

Preferably, the fourth step E4 compares the total quantity of charges 9 collected in the cluster 15 with the total quantity of charges 9 in the standard cluster 15b. In this example, confrontation is performed by means of the confrontation system 26. According to this variant, the method further comprises a fifth step E5 to eliminate the clusters 15 evidenced at the fourth step E4. In this example of embodiment, elimination is performed by means of the elimination system 22.

According to one variant advantageously adapted to eliminate the effects of ion back bombardment, the method further comprises a sixth step E6 to confront the determined characteristic(s) of cluster 15 with at least one characteristic of a model cluster 15c resulting from ion back bombardment, in order to identify whether the cluster 15 results from ion back bombardment. The method therefore compares cluster 15 with the model cluster 15c which is of known profile, so as to determine whether these clusters 15, 15c are similar.

The characteristics of the model cluster 15c are known per se and the choice of characteristic(s) is purely arbitrary and is dependent upon the embodiment of the method of the invention. Preferably, the sixth step E6 compares the total quantity of charges 9 collected in cluster 15 with the total quantity of charges 9 in the model cluster 15c. In the illustrated example of embodiment, confrontation is performed by means of the similarity search system 28.

In this variant, the method further comprises a seventh step E7 to eliminate the clusters 15 evidenced at the sixth step E6. In the illustrated example of embodiment, elimination is performed by means of the elimination system 22.

According to one variant advantageously adapted to eliminate the effects of electronic emission background noise, the method further comprises an eighth step E8 to determine the position of the photon 5 at the origin of each cluster 15 that is identified and non-eliminated. In the illustrated example, the determination of the position of the photon 5 is performed by means of the determination system 29 determining the position of the photon 5.

The method further comprises a ninth step E9 to store at least part of all the determined positions, performed in this example by means of the storage system 30 of the device 1. According to this variant, each new determined position is compared with the positions stored at a tenth step E10, and the new positions which are not included in the stored positions are identified from the result of the comparison at an eleventh step E11 to evidence the positions resulting from electronic emission background noise.

In the illustrated example of embodiment, the comparison is performed by means of the comparison system 21 of the device and the identification of the new positions is performed by the identification system 32. In addition, this variant of embodiment comprises a twelfth step E12 to eliminate the new positions evidenced at the eleventh step E11. In this example of embodiment, elimination is performed by means of the elimination system 22.

Evidently the eliminated positions can nevertheless be stored for subsequent comparison with new positions, so that it is possible to identify the onset of a new light source whose photons 5 must not be eliminated.

It is to be noted that the variant of the method adapted to eliminate halo effects, the variant of the method adapted to eliminate the effects of ion back bombardment, and the variant of the method adapted to eliminate the effects of electron emission background noise are not incompatible. A method according to the invention is able to implement one and/or the other of these variants and preferably all three.

Finally the method of the invention comprises a thirteenth step E13 to generate an output signal.

According to one variant of the invention, this signal is a video signal composed of a plurality of images and the thirteenth step E13 consists of generating a video signal from identified and non-eliminated clusters 15 over a given time interval, for example 40 ms, so as to obtain an image frequency of 25 Hz.

According to another variant of the invention, this signal is a digital signal giving the positions of the detected photons 5, and the thirteenth step E13 consists of generating a position signal from each determined, non-eliminated position. On the basis of this step to generate an output signal, the method of the invention according to one variant of embodiment is able to determine the position of a single-photon point emitter per image. The method can be adapted to track the position of this point emitter.

1. Device (1) for detecting photons (5), comprising a sensor (2) including:
a vacuum chamber (3),
a photocathode (4) arranged in the vacuum chamber (3), designed to convert the photons (5) to primary electrons (6) and subjected to an electromagnetic field (E) adapted to accelerate the primary electrons (6),
a converter (8) converting electrons (6) to secondary charges (9), arranged in the vacuum chamber (3) facing the photocathode (4) and adapted to convert at least part of the energy of the accelerated primary electrons (6) into secondary charges (9) collected by a plurality of detection cells (10) set at a regular pitch, the converter (8) optionally converting into secondary charges (9) so-called parasitic electrons not derived directly from the conversion of a photon (5) and possibly being of backscattered type, of the type resulting from ion back bombardment or of the type derived from electronic emission background noise,
an acquisition circuit (13) adapted to read the charges (9) collected by the detection cells (10) with an integration time allowing an impact density to be obtained per unit of time and per unit surface of a cell (10) of the order of a single electron,
said detection device (1) being characterized in that it comprises:
an identification system (14) identifying a cluster (15) of adjacent detection cells (10) of which at least one so-called main cell (10a) comprises a quantity of collected charges (9) higher than a threshold value Vs,
a determination system (19) determining at least one characteristic of the cluster (15),
a memory system (20) memorizing at least one characteristic of a reference cluster (15a) resulting from the conversion of a primary electron (6),
a comparison system (21) comparing the determined characteristic(s) of the cluster (15) with the memorized characteristic(s) of the reference cluster (15a) in order to evidence whether the cluster (15) results from the conversion of a primary electron (6).

2. The device according to claim 1, characterized in that the identification system (14) comprises:
a system (17) for evidencing at least the main cell (10a) whose quantity of collected charges (9) is higher than the threshold value Vs,
a recognition system (18) recognizing the cluster (15), from the charges (9) collected in the cells (10b) adjacent the main cell (10a).

3. The device according to claim 1, characterized in that it comprises an elimination system (22) to eliminate a cluster (15) identified by the comparison system (21) as not resulting from the conversion of a primary electron.

4. The device according to claim 1, characterized in that:
the memory system (20) memorizes at least one characteristic of a standard cluster (15b) resulting from the conversion of a backscattered electron (61),
the device (1) comprises a confrontation system (26) confronting the determined characteristic(s) of the cluster (15) with the memorized characteristic(s) of the standard cluster (15b), in order to evidence whether the cluster (15) results from the conversion of a backscattered electron (61);
the device (1) comprises an elimination system (22) to eliminate a cluster (15) evidenced by the confrontation system (26).

5. The device according to claim 1, characterized in that:
the memory system (20) memorizes at least one characteristic of a model cluster (15c) resulting from ion back bombardment,
the device (1) comprises a similarity search system (28) between the determined characteristic(s) of the cluster (15) and the memorized characteristic(s) of the model cluster (15c) in order to evidence whether the cluster (15) results from ion back bombardment,
the device (1) comprises an elimination system (22) to eliminate a cluster (15) evidenced by the similarity search system (28).

6. The device according to claim 1, characterized in that the device (1) further comprises a system for generating a video signal (33) from clusters (15) identified and non-eliminated over a give time interval.

7. The device according to claim 1, characterized in that the device (1) further comprises:
a determination system (29) determining the position of the photon (5) at the origin of the each identified and non-eliminated cluster (15),
a storage system (30) storing at least part of all the determined positions,
a comparison system (31) comparing each new determined position with the stored positions,
an identification system (32) using the result of the comparison of the new positions which are not included in the stored positions, in order to evidence the positions of electrons resulting from electronic emission background noise by thermionic effect or by field effect,
an elimination system (22) eliminating positions evidenced by the identification system (32).

8. The device according to claim 7, characterized in that the device (1) further comprises a system for generating a position signal (33) from each determined, non-eliminated position.

9. A method for processing data produced by a sensor (2) of the type including:
a vacuum chamber (3),
a photocathode (4) arranged in the chamber (3), designed to convert photons (5) emitted by at least one light source into primary electrons (6) and subjected to an electromagnetic field (E) adapted to accelerate the primary electrons (5),
a converter (8) converting electrons (6) into secondary charges (9), arranged in the chamber (3) facing the photocathode (4) and adapted to convert at least part of the energy of the accelerated primary electrons (6) into secondary charges (9) collected by a plurality of detection cells (10) distributed at a regular pitch, the converter (8) optionally converting to secondary charges (9) so-called parasitic electrons not derived directly from the conversion of a photon (5) and possibly being of backscattered type, of the type resulting from back bombardment or of the type derived from electronic emission background noise,
an acquisition circuit (13) adapted to read the charges (9) collected by the detection cells (10) with an integration time allowing an impact density to be obtained per unit of time and per surface unit of a cell (10) of the order of a single electron,
characterized in that it comprises the following steps repeated successively and continuously:
identifying a cluster (15) of adjacent detection cells (10) of which at least one so-called main cell (10a) comprises a quantity of collected charges (9) higher than a threshold value Vs,
determining at least one characteristic of the cluster (15),
comparing the determined characteristic(s) of the cluster (15) with at least one characteristic of a reference cluster (15a) resulting from the conversion of a primary electron (6), in order to evidence whether the cluster (15) results from the conversion of a primary electron (6).

10. The processing method according to claim 9, characterized in that the identification step of the cluster (15) comprises the following steps:
identifying at least the main cell (10a) whose quantity of collected charges (9) is higher than the threshold value Vs,
recognizing the cluster (15) from the quantity of collected charges (9) in the cells (10b) adjacent the main detection cell (10a).

11. The processing method according to claim 9, characterized in that the method comprises a step to eliminate a cluster (15) identified as not resulting from the conversion of a primary electron (6).

12. The processing method according to claim 9, characterized in that the method comprises:
a confrontation step between the determined characteristic(s) of the cluster (15) and at least one characteristic of a standard cluster (15b) resulting from the conversion of a backscattered electron (6a), in order to identify whether the cluster (15) results from the conversion of the backscattered electron (6a),
a step to eliminate clusters (15) evidenced at the confrontation step.

13. The processing method according to claim 9, characterized in that the method comprises:
a step confronting the determined characteristic(s) of the cluster (15) with at least one characteristic of a model cluster (15c) resulting from ion back bombardment, in order to identify whether the cluster (15) results from ion back bombardment,
a step to eliminate clusters (15) evidenced at the confrontation step.

14. The processing method according to claim 9, characterized in that it further comprises a step to generate a video signal from clusters (15) identified and non-eliminated.

15. The processing method according to claim 9, characterized in that it further comprises the following steps:
determining the position of the photon (5) at the origin of each cluster (15) identified and non-eliminated,
storing at least part of all the determined positions,
comparing each new determined position with the stored positions,
identifying, from the result of comparison, those new positions which are not included in the stored positions, in order to evidence the new positions resulting from electronic background noise,
eliminating the new positions evidenced at the identification step.

16. The processing method according to claim 15, characterized in that it further comprises a step for generating a position signal from the determined, non-eliminated positions.

17. The processing method according to claim 16, characterized in that, from the step for generating a position signal, it consists of determining the position of a single-photon point emitter per image and optionally of tracking the position of this emitter.
